(19) United States
(12) Patent Application Publication
(10) Pub. No.: US 2014/0166357 A1
(43) Pub. Date: Jun. 19, 2014

(54) CURRENT-CONDUCTING PIN FOR HERMETIC TERMINAL

(71) Applicant: EMERSON ELECTRIC CO., St. Louis, MO (US)

(72) Inventors: Katsuhiko Kato, Susono-shi (JP); Hiroshi Yagami, Gotemba-shi (JP); Gerald Ng, Kowloon City (HK); Prasad S. Khadkikar, Shenzhen (CN); Zhang Zhengqi, Shenzhen (CN)

(73) Assignee: EMERSON ELECTRIC CO., St. Louis, MO (US)

(21) Appl. No.: 13/788,513

(22) Filed: Mar. 7, 2013

(30) Foreign Application Priority Data
Dec. 19, 2012 (CN) 2012105568178

(51) Int. Cl. H02G 3/22

(52) U.S. Cl. CPC H02G 3/22
USPC 174/650

(57) ABSTRACT

A current-conducting pin for a hermetic terminal is disclosed. A bimetallic pin includes an exterior jacket of a first metal material and an interior core of a second material. A recess is formed in at least one of the opposite ends of the pin and a sealing material is disposed in the recess and hermetically seals a annular interface between the exterior jacket and the interior core of the pin.

### CROSS-REFERENCE TO RELATED APPLICATIONS

This application claims the benefit and priority of CN 2012105568178, filed Dec. 19, 2012. The entire disclosure of the above application is incorporated herein by reference.

### FIELD

The present disclosure generally relates to hermetic power terminal feed-throughs, and more particularly to current-conducting pins for hermetic power terminal feed-throughs.

### BACKGROUND

This section provides background information related to the present disclosure which is not necessarily prior art.

Conventional, hermetically-sealed, electric power terminal feed-throughs (also referred to as “hermetic terminals”) serve to provide an airtight electrical terminal for use in conjunction with hermetically sealed devices, such as air conditioning (A/C) compressors. In such applications, maintaining a hermetic seal is a critical requirement, and leakage through the hermetic terminal must be effectively precluded.

An exemplary conventional hermetic terminal 100 that is well-known in the art is shown in FIG. 1. In such conventional hermetic terminals 100, an electrically conductive pin 102 is fixed in place within an aperture 104 through a metal body 106 by a fusible sealing glass 108 that forms a hermetic, glass-to-metal seal between the pin 102 and the terminal body 106. Optionally, a ceramic insulating sleeve 110 surrounds each pin 102 on the interior side of the terminal body 106 and is secured in place by the sealing glass 108. Additionally, a resilient electrical insulator 112 can optionally be bonded to the outside surface of the terminal body 106, as well as over the glass-to-metal seal 108 and portions of the current-conducting pins 102.

One known current-conducting pin 120 of a conventional hermetic terminal is shown in FIG. 2. The pin 120 includes a bimetallic construction comprising a steel exterior sheath or jacket 122 surrounding an interior solid copper core 124. Such pins 120 are referred to as copper core steel pins. The copper core steel pin 120 combines the good electrical conductivity of copper, while providing favorable sealing characteristics of the steel with the fusible sealing glass 108.

However, due to the nature of the construction and manufacture of copper core steel pins and the high-pressure environment in which the hermetic terminals employing such pins are often utilized, there exists the potential for a reduction or loss in the hermeticity of the terminal resulting from leakage through the pin, itself. As illustrated in FIG. 3, it has been observed that a void 126 can exist or develop at the circumferential interface 128 between the steel jacket 122 and the copper core 124 of the copper core steel pin 120 due to poor bonding between the two metals. Consequently, there is a potential for a leak path to develop within or through the pin 120.

Therefore, there remains a need to reduce to the potential for leakage in a hermetic terminal via the copper core steel pins in a cost effective and efficient manner.

### SUMMARY

This section provides a general summary of the disclosure, and is not a comprehensive disclosure of its full scope or all of its features.

The present disclosure provides a hermetically-sealed, current-conducting bimetallic pin that is suitable for use in hermetic power terminal feed-throughs.

In one aspect of the disclosure, a current-conducting pin for a hermetic terminal is disclosed to comprise a bimetallic pin having an exterior jacket of a first metal material and an interior core of a second material. The pin has a first end portion and a second end portion. At least one of the end portions has a recess. A sealing material is disposed in the recess and hermetically seals an annular interface between the exterior jacket and the interior core of the pin.

In another aspect of the disclosure, the current-conducting pin comprises a generally cylindrically-shaped body having overall diameter D and extending an overall length L along a longitudinal axis X. The body includes a first end portion, a middle portion and a second end portion. The body has a bimetallic construction, having an exterior jacket comprising steel surrounding an interior core of a second material. The second material can have current-conducting properties that are superior to steel. A recess is included at either one or both of the first and second end portions of the pin, and the recess extends inward along the longitudinal axis X from the respective end portion toward the middle portion of the pin. The recess extends in a direction Y that is lateral to the longitudinal axis X, such that it extends beyond a circumferential interface between the exterior jacket and the interior core. A sealing material is disposed within the recess. The sealing material hermetically seals the circumferential interface between the exterior jacket and the interior core at least at the respective end portion of the pin.

A further aspect of the disclosure provides a method for manufacturing a bimetallic current conducting pin. The bimetallic pin has an exterior metal jacket and an interior core, and may comprise a copper core steel pin. The method comprises first creating a recess in the pin at one or both end portions of the pin and then hermetically sealing the recess with a sealing material. Sealing the recess(es) can be accomplished using well-known soldering or brazing techniques employing known soldering or brazing materials. Alternatively, a fusible sealing glass or an epoxy can be employed as a sealing material. Moreover, the process for manufacturing the copper core steel pin can alternatively, or in addition to creating the sealed recess(es), include mechanically working the pin to plastically deform the exterior jacket such that the exterior jacket is forced laterally inwardly against the interior core. The mechanical working can be performed at one or more specific locations along the length of the pin. Consequently, the mechanical working can result in only localized plastic deformation of the exterior jacket at one or more specific locations along the length of the pin.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a cross-sectional front view of a conventional hermetic terminal;

FIG. 2 is a cross-sectional front view of a conventional copper core steel pin for use in the hermetic terminal of FIG. 1;

FIG. 3A is an enlarged detailed view of an end portion of the copper core steel pin of FIG. 2;

FIG. 3B is a partial end view of the copper core steel pin of FIG. 3A;

FIG. 4 is a front view, in partial cross-section, of an exemplary current conducting pin according to the teachings of the present disclosure;

FIG. 5A is an enlarged detailed view of an end portion of the current conducting pin of FIG. 4;

FIG. 5B is an enlarged detailed view of an end portion of an alternate configuration for the current conducting pin of FIG. 4;

FIG. 6 illustrates a cross-sectional front view of a hermetic terminal including a current conducting pin according to the teachings of the present disclosure shown in partial cross-section; and

FIG. 7 illustrates a cross-sectional front view of an alternate configuration of a hermetic terminal including a current conducting pin according to the teachings of the present disclosure shown in partial cross-section.

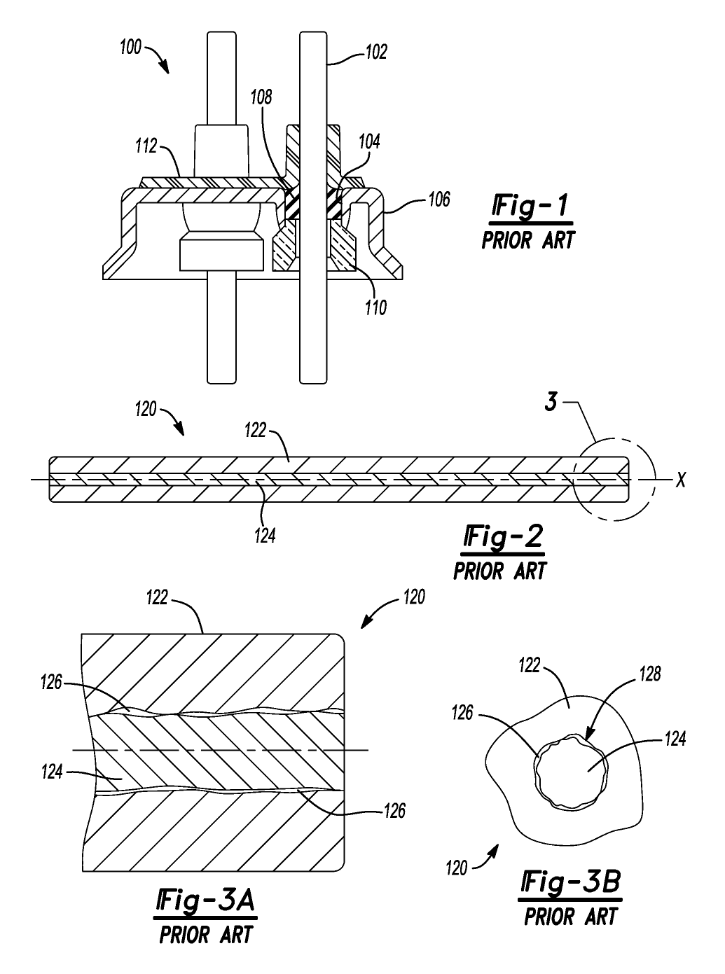

### DETAILED DESCRIPTION

Example embodiments will now be described more fully with reference to the accompanying drawings.

A hermetically-sealed, current-conducting bimetallic pin that is suitable for use in hermetic power terminal feed-throughs is disclosed as included a seal at one or both end portions of the pin. A current-conducting pin for a hermetic terminal comprises a bimetallic pin having an exterior jacket of a first metal material and an interior core of a second material. The pin has a first end portion and a second end portion. At least one of the end portions of the pin includes a hermetic seal comprising a recess in the pin and a sealing material disposed in the recess. The seal at the end portion of the pin hermetically seals an annular interface between the exterior jacket and the interior core of the bimetallic pin.

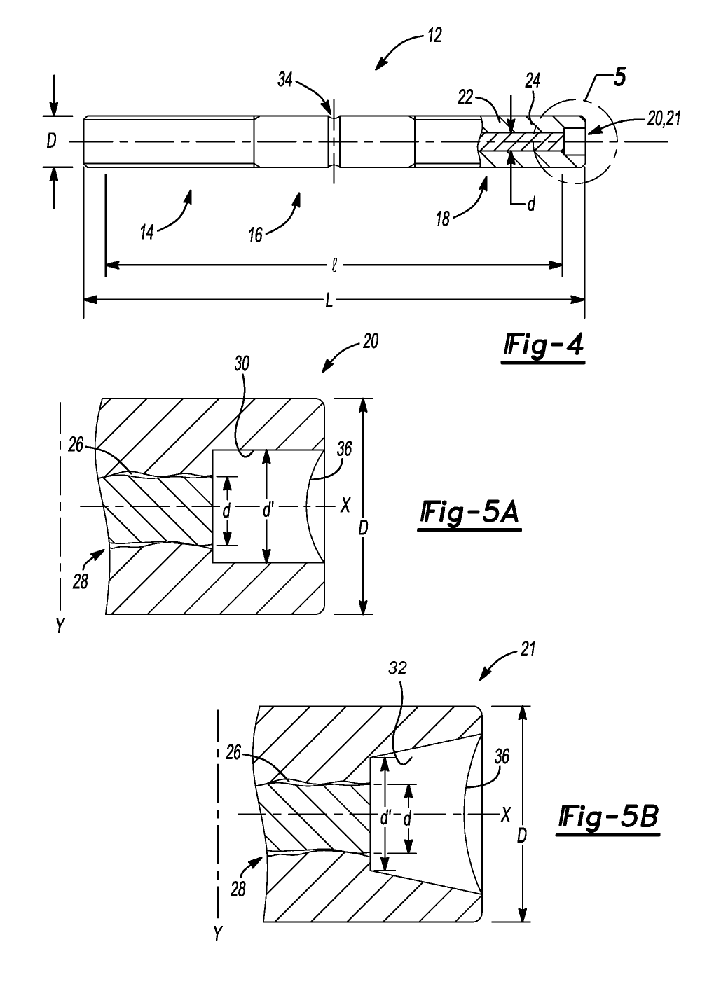

With reference to FIG. 4, an exemplary current conducting pin 12 for a hermetic terminal according to the teachings of the present disclosure is illustrated. The pin 12 is generally cylindrically-shaped and has an overall diameter D and extends an overall length L along a longitudinal axis X. The diameter D generally can range from about 0.10 inches to about 0.500 inches or more. The pin has a first end portion 14, a middle or center portion 16, and a second end portion 18. The pin can optionally be threaded at one or both of the first and second end portions.

The current conducting pin 12 generally comprises a bimetallic construction comprising an exterior sheath or jacket 22 of a first metal material surrounding an interior core 24 of a second metal material. The exterior jacket 22 preferably comprises steel, such as cold rolled steel or stainless steel. The exterior jacket is generally cylindrically-shaped and has both a diameter and length that are the same as the overall diameter D and overall length L of the pin.

The interior core 24 is also generally cylindrically-shaped and generally has a diameter d that is less than the diameter D of the pin and extends a length I that is less than the overall length L of the pin. The interior core 24 preferably comprises a metal having current-conducting properties superior to steel. As non-limiting examples, the interior core 24 can comprise copper, copper alloy, gold, silver, platinum, or aluminum. In addition, it is contemplated that non-metals, such as graphite or current conducting polymers can be used. In a preferred embodiment, the interior core 24 can be pure copper or a copper alloy. The ratio D/d of the diameter D of the pin to the diameter d of the interior core 24 can range from about 1.5:1 to about 3:1 or more.

Referring to FIGS. 4, 5A and 5B, the pin 12 also incorporates a recess 20, 21 that can be included at either one or both of the first and second end portions 14, 18 of the pin 12. The recess(es) 20, 21 can extend inward along the longitudinal axis X from the respective end portion(s) 14, 18 toward the middle portion 16 of the pin 12. The recess(es) 20, 21 have a diameter d′ that is greater than the diameter d of the interior core 24 and less than the overall diameter D of the pin. As such, the recess(es) 20, 21 extend(s) in a direction Y lateral to the longitudinal axis X a distance beyond the circumferential interface 28 between the exterior jacket 22 and the interior core 24 of the pin 12.

The recess can be filled with a sealing material 36 to close and/or hermetically seal off the end portions 14, 18 of the pin 12. Moreover, the sealing material 36 can also extend further inward toward the middle portion 16 of the pin 12 to fill any void(s) between the exterior jacket 22 and the interior core 24 that may be present in the pin 12. With the sealing material 36, therefore, any leak path through the pin 12 that may potentially exist can be interrupted or closed.

Two exemplary pin seals are illustrated in FIGS. 5A and 5B. As shown in a first exemplary configuration of FIG. 5A, the recess 20 can be substantially cylindrically-shaped having an interior sidewall 30 generally parallel with the longitudinal axis X. In a second exemplary configuration shown in FIG. 5B, the recess 21 can be substantially conically-shaped, having an inwardly tapering sidewall 32 at an acute angle relative to the longitudinal axis X. The sealing material 36 substantially fills the recess 20, 21 and can also extend to fill any voids 26 between the exterior jacket 22 and the interior core 24 of the pin 12. As such, one or both end portions 14, 18 of the pin 12 can be hermetically sealed to substantially reduce or eliminate the potential for leakage through the pin 12, itself. Suitable sealing materials 36 can include a soldering material, a brazing material, a sealing glass, or an epoxy.

In addition to one or more recesses 20, 21 in the pin 12, or optionally as an alternative to the recesses 20, 21, the bimetallic pin 12 can be mechanically worked to enhance the bonding and/or close any gaps and/or eliminate any voids between the exterior jacket 22 and the interior core 24 the pin 12. The mechanical working could plastically deform the exterior jacket 22 such that the exterior jacket 22 is forced laterally inwardly and squeezed tightly against the interior core 24, closing any potential leak path through the pin 12. The mechanical working could be performed at one or more specific locations along the length L of the pin 12, resulting in only localized plastic deformation of the exterior jacket 22 such as in the middle portion 16, as shown at location 34 in FIG. 4, or in one or both of the end portions 14, 18. The deformation would not impact the desired current carrying capacity of the pin 12. One form of mechanical working can include swaging. Alternatively, the mechanical working could be performed generally over the entire length of the pin 12.

The sealed, current conducting pin 12 of the present disclosure reduces the potential for leakage through the pin, itself, and is suitable for use in a hermetic terminal having a hermeticity of up to 1×10⁻⁸ atm cc/sec in helium and being used in high pressure environments like air conditioning compressors.

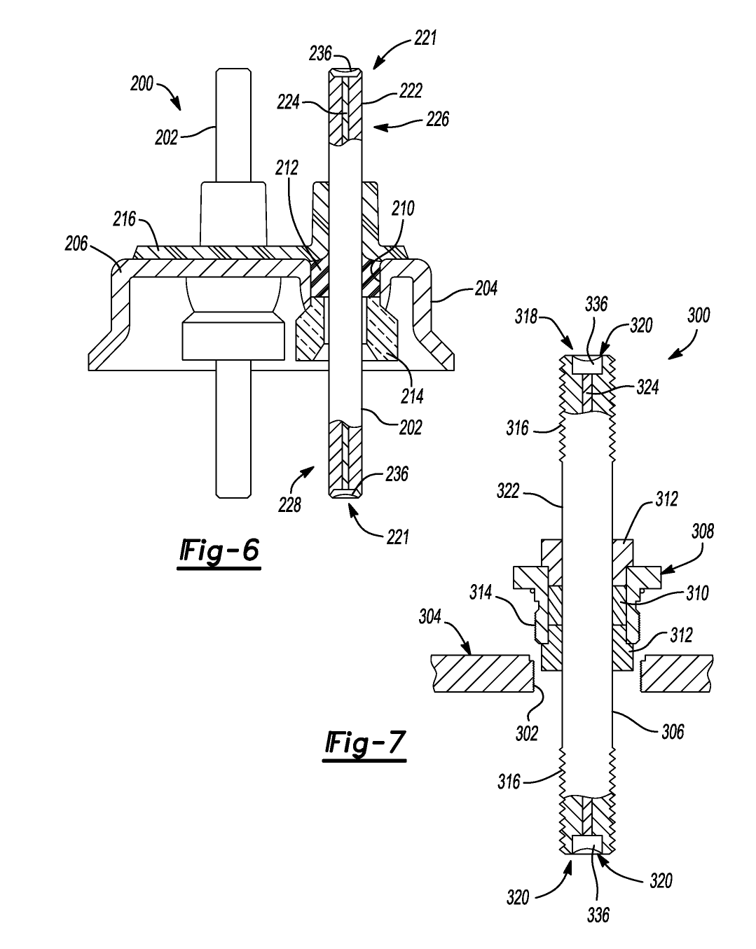

The current conducting pin 12 according to the present disclosure can be used in a hermetic terminal. Two exemplary hermetic terminals are shown in FIGS. 6 and 7.

With reference to FIG. 6, a hermetic terminal 200 includes a plurality of current conducting pins 202 according to the teachings of the present disclosure. The hermetic terminal 200 includes a cup-shaped metallic body 204 having a generally flat bottom wall 206 and a peripheral side wall 208. The bottom wall 206 has a plurality of openings 210 and at least one current-conducting pin 202 extends through each opening 210. A dielectric sealing material comprising a fusible sealing glass 212 extends between and seals the current-conducting pins 202 in the openings 210. The sealing glass 212 forms a hermetic, glass-to-metal seal between the pins 202 and the terminal body 204. A ceramic insulating sleeve 214 can surround each pin 202 on the interior side of the terminal body 204 and is can be secured in place by the sealing glass 212. Additionally, a resilient electrical insulator 216 can bonded to the outside surface of the terminal body 204, as well as over the glass-to-metal seal 212 and portions of the current-conducting pins 202.

The pins 202 have an exterior jacket 222 surrounding an interior core 224. Two recesses 221 are shown to be included one each at an opposite end portion 226, 228 of the pins 202, such as the recess shown in FIG. 5B, for example. A sealing material 236 fills the recesses 221 and seals the pins 202 against potential leakage through the pins 202, themselves. Although two recesses 221 at the opposite end portions of the pins 202 are shown, it is understood that the pins 202 may incorporate only a single recess at one end portion of the pin 202. Additionally, or in the alternative, the pin may be mechanically worked to locally plastically deform the exterior jacket 222 such that the exterior jacket 222 is forced laterally inwardly and squeezed tightly against the interior core 224, closing any potential leak path through the pin 202.

Referring to FIG. 7, another hermetic terminal 300, this one of the type for installation through a threaded bore 302 of a walled housing 304, is disclosed. The hermetic terminal 300 includes a current conducting pin 306 according to the teachings of the present disclosure that is bonded and sealed to an annular sleeve 308 by a fusible sealing glass 310. The sealing glass 310 electrically isolates the current conducting pin 306 from the annular sleeve 308. A pair of annular ceramic insulating sleeves 312 located on opposite sides of the sealing glass 310 further electrically insulates the pin 306 from the annular sleeve 308 and the walled housing 304. The annular sleeve 308 includes threads 314 for attaching the terminal assembly 300 to the threaded bore 302 of the walled housing 304 in which it is installed. The current conducting pin 306 comprises threads 316 at the first and second end portions 318, 320 that are operable to connect the hermetic terminal 300 to external power source(s) or device(s) that are disposed on opposite sides of the walled housing 304.

The pins 306 have an exterior jacket 322 surrounding an interior core 324. Two recesses 320 are shown to be included one each at an opposite end portion 318, 320 of the pins 306, such as the recess shown in FIG. 5A, for example. A sealing material 336 fills the recesses 320 and seals the pins 306 against potential leakage through the pins 306, themselves. Although two recesses 320 at the opposite end portions of the pins 306 are shown, it is understood that the pins 306 may incorporate only a single recess at one end portion of the pin 306. Additionally, or in the alternative, the pin may be mechanically worked to locally plastically deform the exterior jacket 322 such that the exterior jacket 322 is forced laterally inwardly and squeezed tightly against the interior core 324, closing any potential leak path through the pin 306.

The present disclosure additionally provides a method for manufacturing a bimetallic current conducting pin and a hermetic terminal utilizing the pin. The bimetallic pin has an exterior metal jacket and an interior core, and may comprise a copper core steel pin. The method comprises first creating a recess in the pin at one or both end portions of the pin and then hermetically sealing the recess with a sealing material.

Exemplary recesses are illustrated in FIGS. 5A and 5B, although it is understood that the shape of the recess is less critical than the recess being sized to extend in a direction Y lateral to the longitudinal axis X of the pin a distance beyond the annular interface between the exterior jacket and the interior core of the pin. Sealing the recess(es) can be accomplished using well-known soldering or brazing techniques employing known soldering or brazing materials. Alternatively, a fusible sealing glass or an epoxy can be employed as a sealing material. In this regard, known sealing glasses or epoxies can be applied to fill the recess(es) and thereafter fused or cured to create a hermetic seal.

Moreover, while the figures disclose seals at both ends of the pins, it is understood that a seal may alternatively be included at only one end of the pin or at both ends of the pin, as desired.

In other embodiments, the process for manufacturing the copper core steel pin can alternatively, or in addition to the sealed recess(es), comprise a step of mechanically working the pin to plastically deform the exterior jacket such that the exterior jacket is forced laterally inwardly and squeezed tightly against the interior core, closing any potential leak path through the pin. The mechanical working can be accomplished by swaging the pin with a rolling die.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A current-conducting pin for a hermetic terminal comprising:
a generally cylindrically-shaped body having overall diameter D and extending an overall length L along a longitudinal axis X;
the body comprising a first end portion, a middle portion and a second end portion;
the body comprising a bimetallic construction having an exterior jacket comprising steel surrounding an interior core of a second material, the second material having current-conducting properties superior to steel;
a recess included at either one or both of the first and second end portions, the recess extending inward along the longitudinal axis X from the respective end portion toward the middle portion of the body;
the recess further extending in a direction Y lateral to the longitudinal axis X beyond a circumferential interface between the exterior jacket and the interior core; and
a sealing material disposed within the recess that hermetically seals the circumferential interface between the exterior jacket and the interior core at least at the respective end portion of the pin.

2. The current-conducting pin of claim 1 wherein the sealing material hermetically seals a leak path through the pin.

3. The current-conducting pin of claim 1 wherein the sealing material extends from the recess further inward toward the middle portion of the pin and at least partially fills a void between the exterior jacket and the interior core of the pin.

4. The current-conducting pin of claim 1 wherein the sealing material substantially fills the recess.

5. The current-conducting pin of claim 1 wherein the sealing material at least partially fills a void between the exterior jacket and the interior core of the pin.

6. The current-conducting pin of claim 1 wherein the recess comprises a substantially cylindrically-shape.

7. The current-conducting pin of claim 1 wherein the recess comprises a substantially conical shape.

8. The current-conducting pin of claim 1 wherein the pin comprises recesses at both the first and second end portions of the pin.

9. The current-conducting pin of claim 1 wherein the sealing material comprises one of a soldering material, a brazing material, a sealing glass, and an epoxy.

10. The current-conducting pin of claim 1 wherein the exterior jacket is plastically deformed by mechanical working such that the exterior jacket is forced laterally inwardly against the interior core.

11. The current-conducting pin of claim 10 wherein the mechanical working is performed at one or more specific locations along the length L of the pin and results in only localized plastic deformation of the exterior jacket at the location of the mechanical working.

12. The current-conducting pin of claim 11 wherein the location of the mechanical working is at the middle portion of the pin.

13. The current-conducting pin of claim 11 wherein the location of the mechanical working is at one of the first end portion and second end portion of the pin.

14. A hermetic terminal comprising a current-conducting pin according to claim 1.

15. The hermetic terminal of claim 14 further comprising:
a cup-shaped metallic body member including a generally flat bottom wall and a peripheral side wall, the bottom wall having a plurality of first openings therein;
a plurality of current-conducting pins according to claim 1, at least one of the current-conducting pins extending through each first opening; and
a dielectric sealing material extending between the current-conducting pins and the first openings and hermetically sealing the current-conducting pins within the first openings.

16. The hermetic terminal of claim 14 further comprising:
an annular sleeve;
the current-conducting pin extending through the annular sleeve;
a dielectric sealing material comprising a fusible sealing glass that hermetically seals the current-conducting pin to, and electrically isolates the current-conducting pin from, the annular sleeve.

17. The hermetic terminal of claim 16 further comprising a pair of annular ceramic insulating sleeves located on opposite sides of the sealing glass and further electrically isolating the pin from the annular sleeve,

18. A current-conducting pin for a hermetic terminal comprising:
a bimetallic pin comprising an exterior jacket of a first metal material and an interior core of a second material, the pin having a first end portion and a second end portion;
wherein at least one of the first end portion and second end portion comprises a recess; and
wherein a sealing material is disposed in the recess and hermetically seals an annular interface between the exterior jacket and the interior core of the pin.

19. The current-conducting pin of claim 18, wherein the pin comprises a length along a longitudinal axis and the recess extends in a direction lateral to the longitudinal axis beyond the annular interface between the exterior jacket and the interior core of the pin.

20. The current-conducting pin of claim 19, wherein the recess is comprises substantially cylindrical sidewalls.

21. The current-conducting pin of claim 19, wherein the recess comprises tapered sidewalls.

22. The current-conducting pin of claim 21, wherein the tapered sidewalls taper outwardly from an end of the interior core to an end of the current-conducting pin.

23. The current-conducting pin of claim 18 wherein the exterior jacket is plastically deformed by mechanical working such that the exterior jacket is forced laterally inwardly against the interior core.

24. A hermetic terminal comprising a current-conducting pin according to claim 18.

25. The hermetic terminal of claim 24 further comprising:
a cup-shaped metallic body member including a generally flat bottom wall and a peripheral side wall, the bottom wall having a plurality of first openings therein;
a plurality of current-conducting pins according to claim 18, at least one of the current-conducting pins extending through each first opening; and
a dielectric sealing material extending between the current-conducting pins and the first openings and hermetically sealing the current-conducting pins within the first openings.

26. The hermetic terminal of claim 24 further comprising:
an annular sleeve;
the current-conducting pin extending through the annular sleeve;
a dielectric sealing material comprising a fusible sealing glass that hermetically seals the current-conducting phi to, and electrically isolates the current-conducting pin from, the annular.
